(19) United States
(12) Patent Application Publication
(10) Pub. No.: US 2019/0094972 A1
(43) Pub. Date: Mar. 28, 2019

(54) INFORMATION PROCESSING APPARATUS, INFORMATION PROCESSING METHOD, AND NON-TRANSITORY COMPUTER-READABLE MEDIUM

(71) Applicant: SONY CORPORATION, TOKYO (JP)

(72) Inventor: MASAKAZU UKITA, KANAGAWA (JP)

(21) Appl. No.: 16/087,018

(22) PCT Filed: Jan. 25, 2017
(86) PCT No.: PCT/JP2017/002601

§ 371 Date: Sep. 20, 2018

(30) Foreign Application Priority Data
Mar. 30, 2016 (JP) 2016-069360

(51) Int. Cl. G06F 3/01

(52) U.S. Cl. CPC G06F 3/016; G06F 3/014

(57) ABSTRACT

There is provided an information processing apparatus including: a generation unit configured to generate tactile information indicating a tactile sense to be perceived by a user based on a relative moving direction of a reference position relative to a first virtual object in a virtual space, the reference position being moved in the virtual space in response to movement of an operation body in a real space; and an output unit configured to output tactile presentation information for making the user perceive the tactile sense with a tactile presentation device configured to perform tactile presentation based on the tactile presentation information.

### CROSS REFERENCE TO RELATED APPLICATIONS

This application claims the benefit of Japanese Priority Patent Application JP 2016-069360 filed Mar. 30, 2016, the entire contents of which are incorporated herein by reference.

### TECHNICAL FIELD

The present disclosure relates to an information processing apparatus, an information processing method, and a program.

### BACKGROUND ART

In recent years, in a field, e.g., virtual reality, such a technology is proposed to present a sense with a sense of reality in a virtual space to a user. For example, such a technology is proposed to present, to a user, tactile sense when the user touches a virtual object in a virtual space.

For example, in Patent Literature 1, in order to obtain a three-dimensional spatial coordinate input device that can feed back a skin sense, there is disclosed a technology for calculating an amount of control for tactile presentation to a three-dimensional information input/output device by using data for generating a skin sense indicating a friction coefficient value of a virtual-object surface, and performing, with the three-dimensional information input/output device, the tactile presentation by the control of an amount of charges.

### CITATION LIST

### Patent Literature

[PTL 1]

JP 2013-114323A

### SUMMARY

### Technical Problem

However, in the field for tactile presentation, it is considered that it is desirable to more precisely present the tactile sense.

Therefore, in the present disclosure, there is proposed an information processing apparatus, an information processing method, and a program that are novel and improved, and capable of more precisely presenting the tactile sense.

### Solution to Problem

According to an embodiment of the present disclosure, there is provided an information processing apparatus including: a generation unit configured to generate tactile information indicating a tactile sense to be perceived by a user based on a relative moving direction of a reference position relative to a first virtual object in a virtual space, the reference position being moved in the virtual space in response to movement of an operation body in a real space; and an output unit configured to output tactile presentation information for making the user perceive the tactile sense with a tactile presentation device configured to perform tactile presentation based on the tactile presentation information, the generation unit and the output unit each being implemented via at least one processor.

According to an embodiment of the present disclosure, there is provided an information processing method, implemented via at least one processor, the method including: generating tactile information indicating a tactile sense to be perceived by a user based on a relative moving direction of a reference position relative to a first virtual object in a virtual space, the reference position being moved in the virtual space in response to movement of an operation body in a real space; and outputting tactile presentation information for making the user perceive the tactile sense with a tactile presentation device configured to perform tactile presentation based on the tactile presentation information.

According to an embodiment of the present disclosure, there is provided a non-transitory computer-readable medium having embodied thereon a program, which when executed by a computer, causes the computer to execute a method, the method including: generating tactile information indicating a tactile sense to be perceived by a user based on a relative moving direction of a reference position relative to a first virtual object in a virtual space, the reference position being moved in the virtual space in response to movement of an operation body in a real space; and outputting tactile presentation information for making the user perceive the tactile sense with a tactile presentation device configured to perform tactile presentation based on the tactile presentation information.

### Advantageous Effects of Invention

As mentioned above, according to the present disclosure, it is possible to more precisely present the tactile sense.

Note that the effects described above are not necessarily limitative. With or in the place of the above effects, there may be achieved any one of the effects described in this specification or other effects that may be grasped from this specification.

### BRIEF DESCRIPTION OF DRAWINGS

FIG. 1 is an explanatory diagram showing an example of a system configuration of a virtual-space presentation system according to an embodiment of the present disclosure.

FIG. 2 is an explanatory diagram showing another example of a tactile presentation device according to an embodiment.

FIG. 3 is an explanatory diagram showing an example of a functional configuration of an information processing apparatus and the tactile presentation device according to an embodiment.

FIG. 4 is an explanatory diagram showing an example of displaying an image on a head mount display.

FIG. 5 is an explanatory diagram for explaining various tactile receivers.

FIG. 6 is an explanatory diagram showing an example of a function library shown in a data table format according to an embodiment.

FIG. 7 is a flowchart showing an example of a flow of processing performed by the information processing apparatus according to an embodiment.

FIG. 8 is a flowchart showing an example of a flow of drive information generating processing performed by the information processing apparatus according to an embodiment.

FIG. 9 is a flowchart showing an example of a flow of processing performed by the tactile presentation device according to an embodiment.

FIG. 10 is an explanatory diagram for explaining contact between a virtual stick grasped by a virtual hand and a contact object in a virtual space.

FIG. 11 is an explanatory diagram showing an example of a system configuration of a virtual-space presentation system according to a first modification.

FIG. 12 is an explanatory diagram showing an example of a system configuration of a virtual-space presentation system according to a second modification.

FIG. 13 is an explanatory diagram showing an example of a system configuration of a virtual-space presentation system according to a third modification.

FIG. 14 is an explanatory diagram showing an example of a system configuration of a virtual-space presentation system according to a fourth modification.

FIG. 15 is an explanatory diagram showing an example of a hardware configuration of the information processing apparatus according to an embodiment of the present disclosure.

### DESCRIPTION OF EMBODIMENTS

Hereinafter, (an) embodiment(s) of the present disclosure will be described in detail with reference to the appended drawings. In this specification and the appended drawings, structural elements that have substantially the same function and structure are denoted with the same reference numerals, and repeated explanation of these structural elements is omitted.

Note that a description will be given in the following order.

1. Virtual-space Presentation System

2. Functional Configuration

3. Operation

4. Application Example

5. Modification

6. Hardware Configuration

7. Conclusion

### 1. Virtual-Space Presentation System

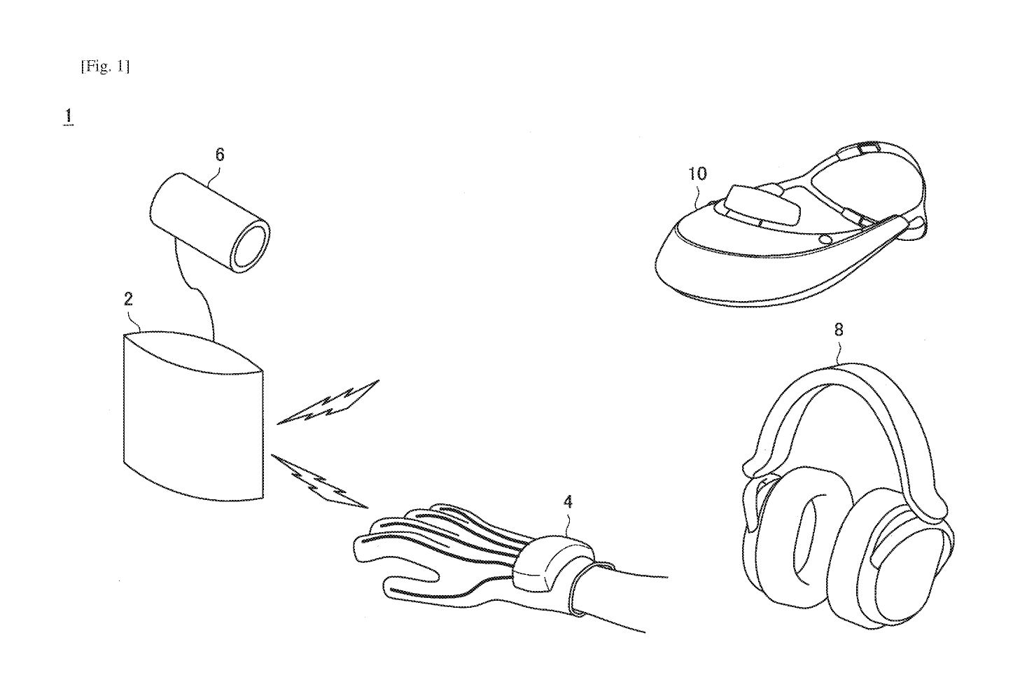

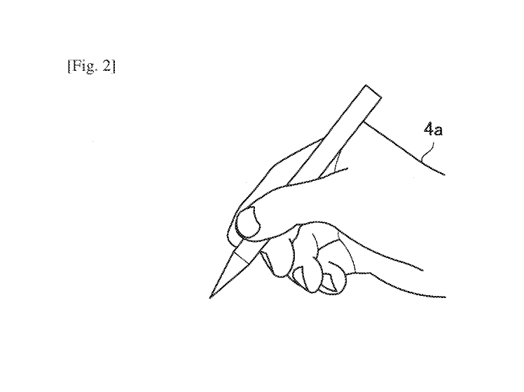

First, a description will be given of a virtual-space presentation system 1 according to an embodiment with reference to FIGS. 1 and 2. FIG. 1 is an explanatory diagram showing an example of a system configuration of the virtual-space presentation system 1 according to an embodiment of the present disclosure. As shown in FIG. 1, the virtual-space presentation system 1 includes: an information processing apparatus 2; a tactile presentation device 4; a position and attitude detection device 6; a headphone 8; and a head mount display 10. The virtual-space presentation system 1 is an example of a system that presents the virtual space to a user. Specifically, the virtual-space presentation system 1 is a system using a technology called virtual reality for presenting a virtual world (hereinbelow, also referred to as a virtual world) with a sense of reality.

The head mount display 10 is an example of a display device that displays an image. The head mount display 10 is used to visually present the sense in the virtual world to the user. Specifically, the head mount display 10 is used in a state in which the head mount display 10 is mounted to the head of the user. The head mount display 10 displays an image showing each object in the virtual space based on an operation instruction sent from the information processing apparatus 2. The head mount display 10 is communicated with the information processing apparatus 2 by a wired or wireless manner.

Further, a sensor for detecting a direction of the head of the user who mounts the head mount display 10 may be provided in the head mount display 10. In this case, a detection result of the relevant sensor is sent to the information processing apparatus 2, and the information processing apparatus 2 outputs the operation instruction based on information indicating the direction of the head of the user to the head mount display 10. As a consequence, the information processing apparatus 2 can display an image corresponding to the direction of the head in the virtual world on the head mount display 10.

The headphone 8 is an example of a sound output device that outputs sound. The headphone 8 is used for tactically presenting the sense in the virtual world to the user. Specifically, the headphone 8 is used in a state in which the headphone 8 is mounted to the head of the user. The headphone 8 outputs sound for expressing sound in the virtual world based on an operation instruction sent from the information processing apparatus 2. The headphone 8 communicates with the information processing apparatus 2 by a wired or wireless manner.

Further, the information processing apparatus 2 may output the operation instruction based on the information indicating the direction of the head of the user to the headphone 8. As a consequence, the information processing apparatus 2 can make the headphone 8 output sound corresponding to the direction of the head in the virtual world.

The tactile presentation device 4 is a device that performs tactile presentation to the user. The tactile presentation device 4 is used to tactically present the sense in the virtual world to the user. Specifically, the tactile presentation device 4 presents, to the user, the tactile sense when the user touches a virtual object in the virtual space. The tactile presentation device 4 is used in a state in which it is fixed to a part (hereinbelow, also referred to as a part) of the body of the user, and is moved in response to movement of the part of the user. For example, the tactile presentation device 4 may be a glove type as shown in FIG. 1. In this case, the tactile presentation device 4 is used in a state in which it is mounted to the hand of the user, and is moved in response to movement of the hand of the user. The tactile presentation device 4 makes the user perceive oscillations as the tactile sense to the user based on the operation instruction sent from the information processing apparatus 2, thereby performing tactile presentation. For example, the tactile presentation device 4 has an oscillator and transmits oscillations of the relevant oscillator to the skin of the user, thereby performing tactile presentation. Specifically, the tactile presentation device 4 generates the oscillations of the relevant oscillator, thereby transmitting the oscillations to the part of the user to make the user perceive the oscillations. The tactile presentation device 4 communicates with the information processing apparatus 2 by a wired or wireless manner.

Note that, the tactile presentation device 4, if capable of performing tactile presentation to the user, may have another configuration. For example, a pen-type tactile presentation device 4a shown in FIG. 2 may be applied to the virtual-space presentation system 1. As shown in FIG. 2, the tactile presentation device 4a is used in a state in which it is grasped by the hand of the user and is moved in response to the movement of the hand of the user.

The position and attitude detection device 6 shown in FIG. 1 detects the position and attitude of the tactile presentation device 4 in a real space, and sends a detection result to the information processing device 2. The position and attitude detection device 6 may have an image sensor and detect the position and attitude of the tactile presentation device 4 from an image obtained by imaging processing. For example, the position and attitude detection device 6 may recognize a specific part of the tactile presentation device 4 from the image obtained by the imaging processing and calculate the position in a real space based on the position and size of the relevant part in the obtained image. The image sensor used for the imaging processing may be an image sensor that can receive electromagnetic waves such as infrared or ultraviolet with a wavelength other than an area of visible light, in addition to an image sensor capable of receiving visible light. The tactile presentation device 4 communicates with the information processing apparatus 2 by a wired or wireless manner.

The information processing apparatus 2 sends an operation instruction to each of the head mount display 10, the headphone 8, and the tactile presentation device 4, in order to present the sense in the virtual world to the user. The information processing apparatus 2 sends various operation instructions based on information on the virtual space to the respective devices. The information on the virtual space includes information on each object in the virtual space and information on virtual sound source in the virtual space. The information on the virtual space used for sending various operation instructions by the information processing apparatus 2 may be stored in advance to a storage element in the information processing apparatus 2 or may be sent to the information processing apparatus 2 from another apparatus different from the information processing apparatus 2.

The information processing apparatus 2 performs various processing so that a reference such as coordinates corresponding to a relevant part is moved in the virtual space in response to the movement of the part of the user as an operation body in a real space. Specifically, the information processing apparatus 2 may have a virtual part displayed on the head mount display 10 based on the relevant reference. In this case, the information processing apparatus 2 performs various processing so that the virtual part as an object corresponding to the relevant part in the visual space is moved in response to the movement of the part of the user in the real space. The virtual part is an example of a second virtual object of an embodiment of the present disclosure displayed based on the reference moved in the virtual space in response to the movement of the part of the user in the real space. Specifically, the information processing apparatus 2 performs various processing so that a virtual hand in the virtual space corresponding to the hand of the user in the real space is moved based on information indicating the position and attitude of the tactile presentation device 4 in the real space sent from the position and attitude detection device 6. For example, the information processing apparatus 2 moves a display position of the virtual hand with the head mount display 10 in response to the movement of the hand of the user in the real space. Further, the information processing apparatus 2 may generate tactile information indicating the tactile sense to be perceived by the user, for example, when the virtual hand in the virtual space touches a contact object as another object, and may send the tactile presentation information for making the user perceive the relevant tactile sense with the tactile presentation device 4 to the tactile presentation device 4. As a consequence, the tactile presentation device 4 performs tactile presentation to the user. The relevant contact object is an example of a first virtual object of an embodiment of the present disclosure that is in contact with the second virtual object in the virtual space.

The information processing apparatus 2 according to an embodiment generates tactile information indicating the tactile sense to be perceived by the user based on a relative moving direction of a reference moved in the virtual space in response to movement of the operation body in the real space relative to the contact object in the virtual space. Thus, proper tactile sense can be perceived by the user in accordance with the relative moving direction of the reference relative to the contact object. Therefore, it is possible to more precisely present the tactile sense. In the following description, a specific description will be mainly given of the information processing apparatus 2 according to an embodiment. In the following description, further, a description will be mainly given of an example in which the information processing apparatus 2 generates oscillation information indicating oscillations as the tactile sense that is perceived by the user as tactile information and the tactile presentation information for making the user perceive the oscillations with the tactile presentation device 4 is sent to the tactile presentation device 4.

### 2. Functional Configuration

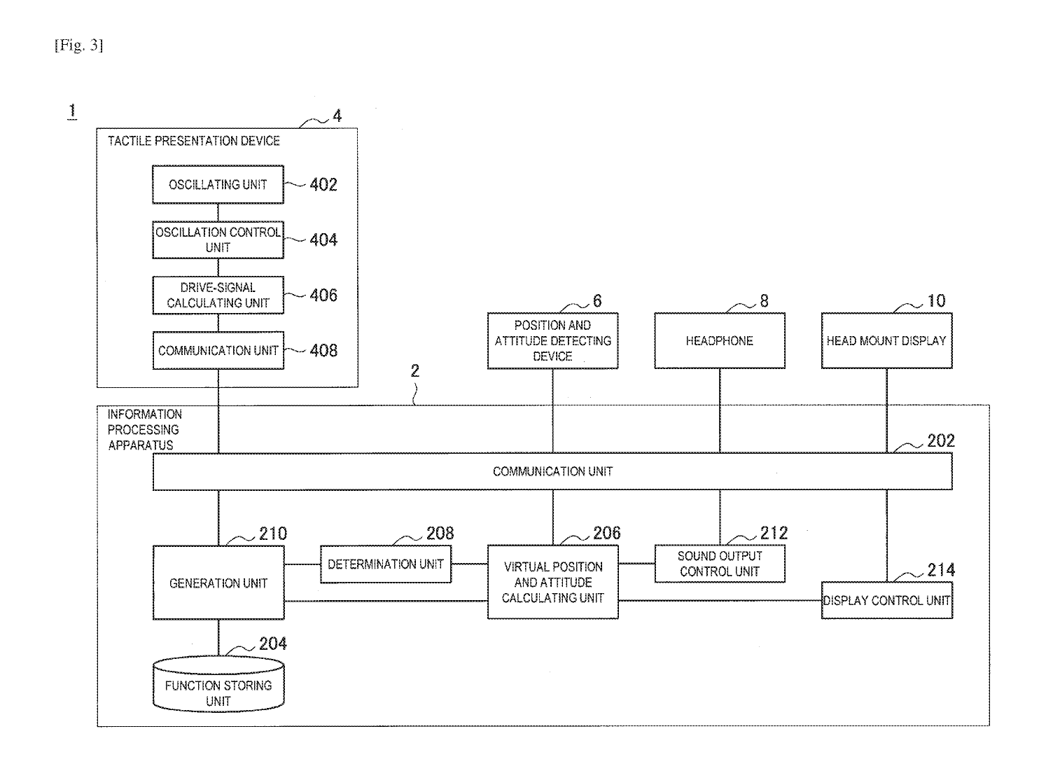

Subsequently, a description will be given of an example of the functional configuration of the information processing apparatus 2 according to an embodiment with an example of the functional configuration of the tactile presentation device 4. FIG. 3 is an explanatory diagram showing an example of the functional configuration of the information processing apparatus 2 and the tactile presentation device 4 according to an embodiment.

### Information Processing Apparatus

First, a description will be given of an example of the functional configuration of the information processing apparatus 2. As shown in FIG. 3, the information processing apparatus 2 includes: a communication unit 202; a function storing unit 204; a virtual position and attitude calculating unit 206; a determination unit 208; a generation unit 210; a sound output control unit 212; and a display control unit 214.

(Communication Unit)

The communication unit 202 communicates with an external device of the information processing apparatus 2. Specifically, the communication unit 202 receives information indicating the position and attitude of the tactile presentation device 4 in the real space from the position and attitude detection device 6, and outputs the received information to the virtual position and attitude calculating unit 206. Further, the communication unit 202 sends various operation instructions output from the sound output control unit 212 and the display control unit 214 to the headphone 8 and the head mount display 10, respectively. Furthermore, when information indicating a direction of the head of the user is received from the head mount display 10, the communication unit 202 outputs the relevant information to the sound output control unit 212 and the display control unit 214.

Moreover, the communication unit 202 has a function as an output unit that outputs the tactile presentation information for making the user perceive the oscillations with the tactile presentation device 4. Specifically, the communication unit 202 sends oscillation information indicating the oscillations to make the user perceive the oscillations generated by the generation unit 210 as the tactile presentation information to the tactile presentation device 4. Note that a specific description will be given of the oscillation information generated by the generation unit 210 later.

(Function Storing Unit)

The function storing unit 204 stores data referred to for generation processing of the oscillation information in the generation unit 210. Specifically, the function storing unit 204 stores a function library as a set of candidates of a function for generating the oscillation information. The candidates of the relevant function are stored, linked to information indicating each material. Note that the details of the function library will be described later. Further, the function storing unit 204 may store another data referred to for various processing in the information processing apparatus 2.

(Virtual Position and Attitude Calculating Unit)

The virtual position and attitude calculating unit 206 calculates the position and attitude of a virtual part moved in the virtual space in response to movement of the part of a user in the real space, and outputs the calculated result to the determination unit 208, the generation unit 210, the sound output control unit 212, and the display control unit 214. Specifically, the information processing apparatus 2 calculates the position and attitude of the virtual hand as the virtual part in the virtual space based on information indicating the position and attitude of the tactile presentation device 4 in the real space sent from the position and attitude detection device 6. The position and attitude of the virtual hand as the calculated virtual part in the virtual space correspond to a reference moved in the virtual space in response to the movement of the part of the user in the real space.

(Display Control Unit)

The display control unit 214 controls the display of an image on the head mount display 10. Specifically, the display control unit 214 controls the sending of the operation instruction to the head mount display 10 with the communication unit 202, thereby controlling the display of the image on the head mount display 10. For example, the display control unit 214 may control the display of an image showing each object on the head mount display 10 based on the information on each object in the virtual space. Here, the information on each object in the virtual space may include, for example, at least one of information indicating the position of each object, information indicating the shape of each object, information indicating the texture of a surface of each object, and information indicating color of the surface of each object. Further, the display control unit 214 may make the head mount display 10 display the virtual part based on the reference moved in the virtual space in response to movement of the part of the user in the real space. Specifically, the display control unit 214 may make the head mount display 10 display the virtual hand based on the position and attitude of the virtual hand as the calculated virtual part in the virtual space.

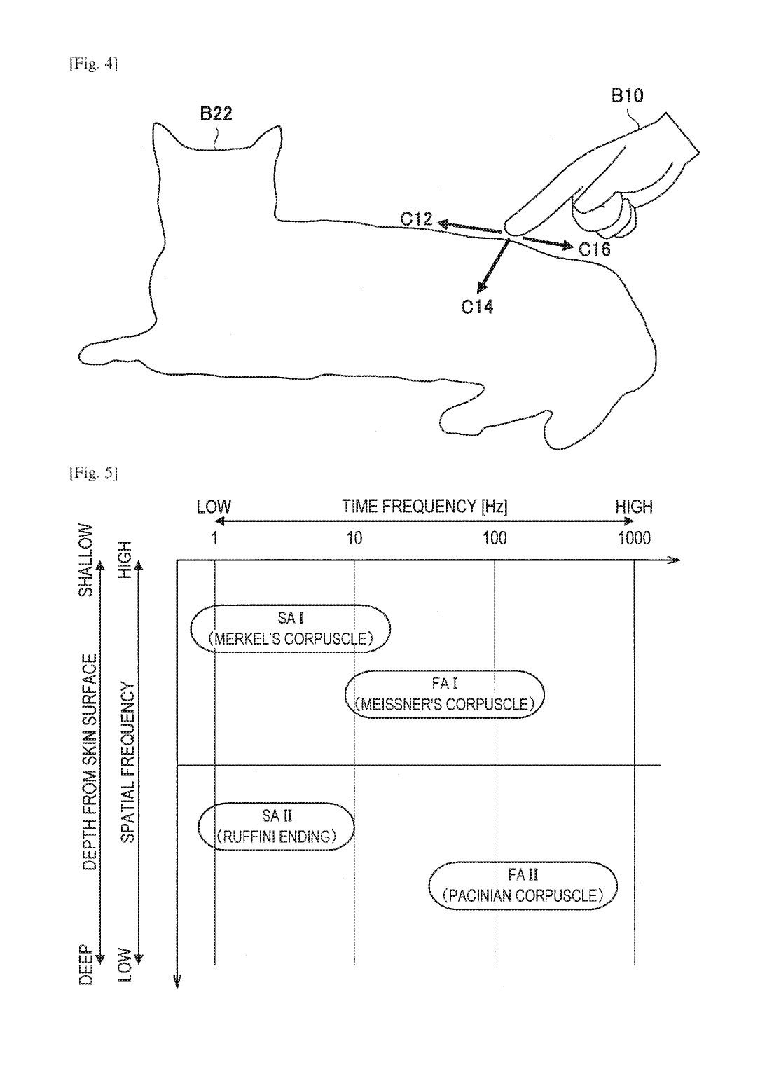

FIG. 4 is an explanatory diagram showing an example of display of an image on the head mount display 10. In FIG. 4, a virtual hand B10 moved in the virtual space in response to the movement of the hand of the user in the real space and a virtual cat B22 as a contact object are displayed. The display control unit 214 makes a display position of the virtual hand B10 move in accordance with information indicating the position and attitude of the virtual hand B10 calculated by the virtual position and attitude calculating unit 206. Note that the display control unit 214 may control the display of the image on the head mount display 10 based on the information indicating the direction of the head of the user.

(Sound Output Control Unit)

The sound output control unit 212 shown in FIG. 3 controls a sound output by the headphone 8. Specifically, the sound output control unit 212 controls the sending of the operation instruction to the headphone 8 with the communication unit 202, thereby controlling the sound output by the headphone 8. For example, the sound output control unit 212 may control the sound output by the headphone 8 based on information on a virtual sound source in the virtual space. Specifically, the sound output control unit 212 may change the balance between sound volume on the right-ear side and sound volume on the left-ear side of the user in the sound output by the headphone 8, and may increase or decrease both the sound volumes on the right-ear side and the left-ear side of the user. Note that the sound output control unit 212 may control the sound output by the headphone 8 based on information indicating the direction of the head of the user.

(Determination Unit)

The determination unit 208 determines whether or not the virtual part contacts with the contact object in the virtual space, and outputs a determination result to the generation unit 210. Specifically, the determination unit 208 determines whether or not the virtual part contacts with the contact object based on a relationship between the position and attitude of the virtual part calculated by the virtual position and attitude calculating unit 206 and the position and attitude of the contact object. For example, the determination unit 208 determines that the virtual hand B10 contacts with the virtual cat B22 when a part of the virtual hand B10 shown in FIG. 4 is partly overlapped with the virtual cat B22.

(Generation Unit)

The generation unit 210 generates tactile information indicating the tactile sense to be perceived by the user. For example, when the virtual part contacts with the contact object, the generation unit 210 generates oscillation information indicating oscillations to be perceived by the user. Specifically, when the determination unit 208 determines that the virtual part contacts with the contact object in the virtual space, the generation unit 210 generates the oscillation information. The generated oscillation information is output to the communication unit 202, and is sent to the tactile presentation device 4 by the communication unit 202. The oscillation information may include information indicating a relationship among a time frequency, a spatial frequency, and an amplitude. Hereinbelow, the oscillation information will be described.

Frequency characteristics of oscillations perceived by a person as the tactile sense can be expressed by two frequencies of the time frequency and the spatial frequency. The time frequency corresponds to a period of time change of the oscillation. The spatial frequency is a value corresponding to spatial density at a portion where oscillations are generated on the skin surface where the oscillations are detected. A surface layer part of the human skin includes Meissner's corpuscle (FAI), Pacinian corpuscle (FAII), Merkel's corpuscle (SAI), and Ruffini ending (SAII). A person can sense the tactile sense corresponding to the detection result of the stimuli with the respective receivers.

Here, as shown in FIG. 5, frequency characteristics of the oscillation that can be detected by the respective receivers are different from each other. FIG. 5 shows ranges of the time frequency and the spatial frequency that can be detected by the respective receivers. As shown in FIG. 5, as the depth of the receiver from the skin surface is shallower, the detectable spatial frequency is higher. When oscillations are generated in the skin surface, values of the oscillations of the time frequency and the spatial frequency detectable by the respective receivers correspond to an amount of detection by the relevant respective receivers. For example, a value of the oscillations with frequency characteristics when the time frequency is low and the spatial frequency is high corresponds to an amount of detection of Merkel's corpuscle. A value of the oscillations with frequency characteristics when the time frequency is high and the spatial frequency is low corresponds to an amount of detection of Pacinian corpuscle.

In the case of performing the tactile presentation by making the user perceive the oscillations, the user can sense the tactile sense in accordance with the relationship among the time frequency, the spatial frequency, and the amplitude of the oscillations to be perceived by the user. In the virtual-space presentation system 1, the tactile presentation device 4 specifically performs the tactile presentation by making the user perceive the oscillations corresponding to information indicating a relationship among the time frequency, the spatial frequency, and the amplitude generated by the generation unit 210. Therefore, the tactile sense in accordance with the information indicating the relationship among the time frequency, the spatial frequency, and the amplitude generated by the generation unit 210 is presented to the user. Hereinbelow, a specific description will be given of generation of the oscillation information by the generation unit 210.

The generation unit 210 may generate the oscillation information based on the information indicating characteristics of a part that is determined to contact with the virtual part of the contact object. For example, the generation unit 210 may generate the oscillation information based on information indicating a virtual material of the part that is determined to contact with the virtual part of the contact object. Specifically, the generation unit 210 retrieves a function linked to information indicating the virtual material of the part determined to contact with the virtual part of the contact object from a function library stored in the function storing unit 204, and generates the oscillation information by using the retrieved function. As mentioned above, a candidate of the function included in the function library is stored, linked to the information indicating each material. Further, information indicating the virtual material of each object is preset. The generation unit 210 specifies the virtual material of a part determined to contact with the virtual part of the contact object based on the position and attitude of the virtual part calculated by the virtual position and attitude calculating unit 206, the position and the attitude of the contact object, and the information indicating the material of each object.

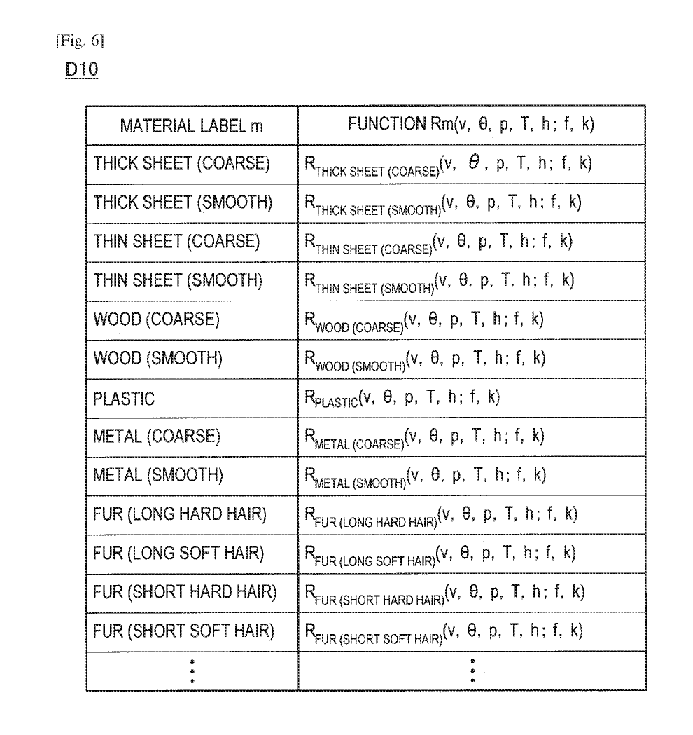

FIG. 6 is an explanatory diagram showing an example of a function library D10 shown by a data table format. As shown in FIG. 6, in the function library D10, in each line, a material label m indicating the material is linked to a function Rm (v, θ, p, T, h; f, k). For example, a material label “thick sheet (coarse)”, a material label “thick sheet (smooth)”, and a material label “thin sheet (coarse)”, are linked to a function R thick sheet (coarse) (v, θ, p, T, h; f, k), a function R thick sheet (smooth) (v, θ, p, T, h; f, k), and a function R thin sheet (coarse) (v, θ, p, T, h; f, k), respectively. When the virtual material of a part determined to contact with the virtual part of the contact object is a wood material (coarse), for example, the generation unit 210 retrieves the function R wood material (coarse) (v, θ, p, T, h; f, k) linked to a material label “wood material (coarse)” from the function library D10. It is considered that a type of the virtual material set to each object in the virtual space is finite. Therefore, as mentioned above, the oscillation information is generated by using the function retrieved from the candidates of the function linked to the information indicating each material, thereby reducing the amount of information used for generation of the oscillation information. Thus, it is possible to save an amount of usage of the memory. Note that, in the following description, the function Rm (v, θ, p, T, h; f, k) is also referred to as a function R.

The function R prescribes a relationship among respective parameters, a time frequency f, a spatial frequency k, and an amplitude. The generation unit 210 generates, as the oscillation information, a response function r(f, k) indicating the relationship among the time frequency f, the spatial frequency k, and the amplitude by substituting the respective parameters to the function R. The respective parameters include, for example, a relative velocity v of the reference in the virtual space corresponding to the part of the user relative to the contact object when the virtual part contacts with the contact object, a relative moving direction θ of the relevant reference relative to the contact object, a virtual pressure p that is applied to the contact object by the virtual part, a virtual temperature T of a part determined to touch the virtual part of the contact object, and a virtual humidity h of a part determined to contact with the virtual part of the contact object. As mentioned above, the generation unit 210 may generate the response function r(f, k) as the oscillation information based on the velocity v, the moving direction θ, the pressure p, the temperature T, and the humidity h. Note that the parameter in the generation of the response function r(f, k) may include at least the moving direction θ, and may omit at least one of the velocity v, the pressure p, the temperature T, and the humidity h.

The tactile sense sensed when touched to the object can change depending on the respective parameters. For example, the tactile sense to an object with material such as rubber or fur easily changes depending on the temperature or humidity. Further, the tactile sense to an object with particularly soft material easily changes depending on pressure applied to the relevant object when touched to the relevant object. Furthermore, as a relative velocity between the relevant object and the part of the person who touches the relevant object is higher, it is difficult to detect the difference in fine shape of a surface of the relevant object. As mentioned above, it is possible to more precisely present the tactile sense corresponding to the respective parameters by generating the oscillation information based on information indicating the velocity v, the pressure p, the temperature T, or the humidity h.

The generation unit 210 calculates, from the respective parameters, the velocity v, the moving direction θ, and the pressure p, based on the information indicating the position and attitude of the virtual part calculated by the virtual position and attitude calculating unit 206. Here, the generation unit 210 may calculate, for example, the pressure p in accordance with the distance at which the surface of the virtual part enters an inner side of the contact object or the volume of an area where the virtual part is overlapped with the contact object. Note that the generation unit 210 may use a value obtained by measuring the pressure generated at the part of the user in the real space, as the pressure p. For example, in the case of detecting movement of the finger of the user by using a pressurizing-type touch panel, the generation unit 210 may use a value obtained by measuring pressure generated at the finger of the user in the real space with the relevant pressurizing-type touch panel, as the pressure p.

Moreover, the generation unit 210 may use a value preset in the virtual space as the temperature T and the humidity h among the respective parameters. Here, when the temperature or humidity is not set to the contact object that contacts with the virtual part, the generation unit 210 may use a value set to environment around the contact object in the virtual space, as the temperature T or humidity h. Further, the generation unit 210 may use a fixed value as the temperature T or humidity h.

The generation unit 210 according to an embodiment generates tactile information indicating the tactile sense to be perceived by the user based on a relative moving direction of the reference moved in the virtual space in response to movement of an operation body in the real space relative to a first virtual object in the relevant virtual space. Specifically, the generation unit 210 generates oscillation information indicating oscillations to be perceived by the user based on the relative moving direction of the reference moved in the virtual space in response to the movement of the part of the user in the real space relative to the contact object in the relevant virtual space. Further, the generation unit 210 may generate the oscillation information based on the relative moving direction of the reference relative to the contact object in a state in which it is determined that the contact object contacts with the virtual part. There may be a case where the surface shape of the object in the real space has anisotropy. In such a case, there may be a case where the tactile sense sensed when touching the surface of the relevant object is varied depending on the relative moving direction of the part of a person relative to the relevant object when the relevant object touches the part of the person. Therefore, it is possible to more precisely present the tactile sense by generating the oscillation information indicating the oscillations to be perceived by the user based on the relative moving direction of the reference moved in the relevant virtual space in response to the movement of the part of the user in the real space relative to the contact object in the virtual space.

For example, the generation unit 210 may generate oscillation information different between when a relative moving direction of the reference corresponding to the virtual hand B10 relative to the virtual cat B22 in the case of determining that the virtual hand B10 shown in FIG. 4 touches the virtual cat B22 is a direction C12 and when the relative moving direction is a direction C14 different from the direction C12. Since there may be a case where hair grows on the surface of the cat in the real space, the surface shape of the cat can have anisotropy. Therefore, it is possible to more precisely present the tactile sense when the cat is touched by generating the oscillation information based on the relative moving direction of the reference corresponding to the virtual hand B10 relative to the virtual cat B22.

Further, the generation unit 210 may generate oscillation information different between when the relative moving direction of the reference corresponding to the virtual part relative to the contact object is a first direction and when the relative moving direction is a second direction substantially opposite to the relevant first direction. For example, the generation unit 210 may generate oscillation information different between when the relative moving direction of the reference corresponding to the virtual hand B10 relative to the virtual cat B22 is the direction C12 when it is determined that the virtual hand B10 shown in FIG. 4 touches the virtual cat B22 and when the relative moving direction is the direction C16 substantially opposite to the direction C12. There may be a case where hair grows in one direction on the surface of the cat in the real space. In a case of touching the surface of the cat while moving the hand along the direction in which hair grows, when the moving directions of the hand are opposite to each other, different tactile sense may be sensed. Specifically, there may be a case where different tactile sense may be sensed between when moving the hand from the root to the end of the hair and when moving the hand in a bristling direction. Therefore, different oscillation information is generated between when the relative moving direction of the reference corresponding to the virtual hand B10 relative to the virtual cat B22 is the direction C12 and when the relative moving direction is a direction C16, thereby more precisely presenting the tactile sense sensed when the cat is touched.

The generation unit 210 may generate the oscillation information based on information indicating a degree of sweating of the part of the user. In the case, for example, a sensor that detects the amount of sweating of the part of the user is provided, and a detection result can be sent to the information processing apparatus 2 from the relevant sensor. The generation unit 210 generates the oscillation information based on the information indicating the amount of sweating sent from the relevant sensor. Moreover, the generation unit 210 may estimate the amount of sweating of the part of the user based on living-body information such as a heart rate of the user, and generate the oscillation information based on the estimated amount of sweating. In this case, for example, a sensor that detects vital information such as the heart rate of the user may be provided to send the detection result to the information processing apparatus 2 from the relevant sensor. Further, the generation unit 210 may extract information indicating the facial expression or eye's motion of the user from an image of the face of the user obtained by imaging processing in the estimation of the amount of sweating, and estimate the amount of sweating of the part of the user based on the relevant information. In this case, for example, an imaging device that images the face of the user may be provided to send information indicating the image of the face of the user from the relevant imaging device to the information processing apparatus 2. As mentioned above, it is possible to more precisely present the tactile sense in accordance with the degree of sweating of the part of the user by generating the oscillation information based on the information indicating the degree of sweating of the part of the user.

Moreover, the generation unit 210 may retrieve a function from candidates of the function linked to information indicating the virtual material of the contact object with possibility of contacting with the virtual part of function candidates. For example, the generation unit 210 may specify the virtual material of the contact object with possibility of contacting with the virtual part in accordance with scenes in the virtual space. Specifically, the generation unit 210 specifies a wood material as a virtual material of the contact object with the possibility of contacting with the virtual part when a scene in the virtual space is a forest. In this case, the generation unit 210 retrieves a function from a function R wood material (coarse) (v, θ, p, T, h; f, k) and a function R wood material (smooth) (v, θ, p, T, h; f, k) respectively corresponding to material labels “wood material (coarse)” and “wood material (smooth)” of the function library D10 shown in FIG. 6. Further, the generation unit 210 may specify a virtual material of an object displayed on the head mount display 10 as a virtual material of the contact object with the possibility of contacting with the virtual part. As mentioned above, it is possible to retrieve the function from the candidates of the function linked to the information indicating the virtual material of the contact object with possibility of contacting with the contact object from the function candidates, thereby reducing load of calculating processing.

Further, the generation unit 210 may generate the oscillation information based on information indicating characteristics of a part of the virtual part determined to contact with the contact object. For example, the generation unit 210 may generate the oscillation information based on information indicating the virtual material of a part of the virtual part determined to contact with the contact object. For example, the generation unit 210 retrieves a function linked to the information indicating the virtual material of the part of the virtual part determined to contact with the contact object from the function library D10 and generates the oscillation information by using the retrieved function. Specifically, the generation unit 210 retrieves, from the function library D10, a function linked to information indicating the virtual material of the part of the contact object determined to contact with the virtual part and a function linked to the information indicating the virtual material of the part of the virtual part determined to contact with the contact object, respectively. Subsequently, the generation unit 210 may generate the oscillation information, for example, by using a function obtained by multiplying the two retrieved functions. As a consequence, it is possible to more precisely present the tactile sense based on the virtual materials of the virtual part and the contact object.

### Tactile Presentation Device

Subsequently, a description will be given of an example of a functional configuration of the tactile presentation device 4. As showing in FIG. 3, the tactile presentation device 4 includes a communication unit 408, a drive-signal calculating unit 406, an oscillation control unit 404, and an oscillating unit 402.

(Communication Unit)

The communication unit 408 communicates with an external device of the tactile presentation device 4. Specifically, the communication unit 408 receives a response function r(f, k) generated by the information processing apparatus 2 as oscillation information from the information processing apparatus 2, and outputs the information to the drive-signal calculating unit 406.

(Drive-Signal Calculating Unit)

The drive-signal calculating unit 406 calculates a drive signal a(t) for driving the oscillating unit 402 to make the user perceive oscillations indicated by the oscillation information based on the oscillation information output from the communication unit 408, and outputs the signal to the oscillation control unit 404. Specifically, the drive-signal calculating unit 406 calculates the drive signal a(t) for generating oscillations corresponding to the response function r(f, k) generated by the information processing apparatus 2 by the oscillating unit 402. The calculated drive signal a(t) is specifically a signal showing a current value or a voltage value.

(Oscillation Control Unit)

The oscillation control unit 404 controls the driving of the oscillating unit 402. For example, the oscillating unit 402 has an oscillator, and the oscillation control unit 404 controls the oscillations of the relevant oscillator based on the response function r(f, k) as the oscillation information. Specifically, the oscillation control unit 404 controls the oscillations of the oscillator of the oscillating unit 402 based on the drive signal a(t) output from the drive-signal calculating unit 406. Under control of the oscillations of the oscillator with the oscillation control unit 404, the response function r(f, k) is used as information for controlling the time frequency or amplitude of the oscillations generated by the oscillator. In other words, the tactile presentation information may include the information for controlling the time frequency or amplitude of the oscillations generated by the oscillator.

(Oscillating Unit)

The oscillating unit 402 generates the oscillations based on an operation instruction from the oscillation control unit 404, thereby making the user perceive the relevant oscillations. Consequently, the tactile sense is presented to the user. The oscillating unit 402 specifically generates oscillations corresponding to the response function r(f, k) generated by the information processing apparatus 2 based on the drive signal a(t). The relevant function can be realized by, e.g., a piezo-element, a shape-memory alloy element, a polymeric actuator, a pneumatic actuator, a static actuator, an ultrasonic generating device, an eccentric motor, a linear vibrator, or a voice coil motor. The oscillating unit 402 makes the user perceive the oscillations, thereby presenting the tactile sense to the user. Note that, when a spatial frequency k of oscillations that can be generated by the oscillating unit 402 is a fixed value, the oscillating unit 402 may generate oscillations with a relationship between a time frequency f obtained by substituting the relevant fixed value to the response function r(f, k) generated by the information processing apparatus 2 and the amplitude.

As mentioned above, the information processing apparatus 2 according to an embodiment sends, to the tactile presentation device 4, the response function r(f, k) as the oscillation information indicating the oscillations to be perceived by the user generated by the generation unit 210, as the tactile presentation information. Further, the tactile presentation device 4 calculates the drive signal a(t) for generating the oscillations corresponding to the response function r(f, k) by the oscillating unit 402, and generates the oscillations corresponding to the response function r(f, k). As mentioned above, the function for generating the oscillations by the tactile presentation device 4 is realized by various mechanisms, and the drive signal a(t) for generating the oscillations corresponding to the response function r(f, k) by the oscillating unit 402 may be varied depending on used mechanisms. Therefore, the drive signal a(t) is calculated on the side of the tactile presentation device 4, thereby realizing the reduction in calculating load and the saving of an amount of used memory with the information processing apparatus 2. Further, when generating the oscillations corresponding to the same response function r(f, k) in the tactile presentation device 4 having different mechanisms for generating the oscillations, the response function r(f, k) sent by the information processing apparatus 2 is made common, thereby performing flexible correspondence to the change of types of the used tactile presentation device 4.

### 3. Operation

Subsequently, a description will be given of processing flows of the information processing apparatus 2 and the tactile presentation device 4 according to an embodiment.

(Processing Performed by Information Processing Apparatus)

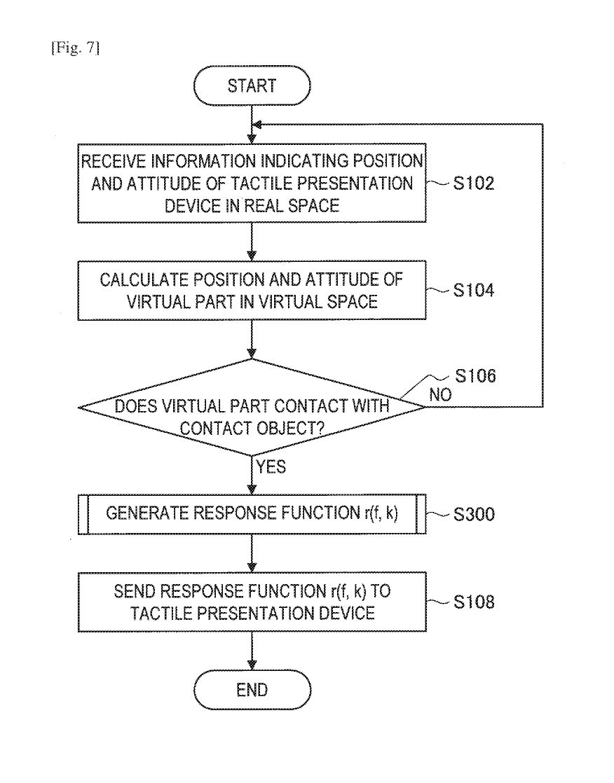

FIG. 7 is a flowchart showing an example of a processing flow performed by the information processing apparatus 2 according to an embodiment. As shown in FIG. 7, the communication unit 202 firstly receives, from the position and attitude detection device 6, information indicating the position and attitude of the tactile presentation device 4 in the real space (step S102), and outputs the received information to the virtual position and attitude calculating unit 206. Next, the virtual position and attitude calculating unit 206 calculates the position and attitude of the virtual part in the virtual space based on the information indicating the position and attitude of the tactile presentation device 4 in the real space sent from the position and attitude detection device 6 (step S104). The determination unit 208 determines whether or not the virtual part contacts with the contact object in the virtual space (step S106).

If the determination unit 208 does not determine that the virtual part contacts with the contact object in the virtual space (NO in step S106), the process returns to processing in step S102. On the other hand, if the determination unit 208 determines that the virtual part contacts with the contact object in the virtual space (YES in step S106), the generation unit 210 generates the response function r(f, k) as the oscillation information indicating the oscillations to be perceived by the user when the virtual part contacts with the contact object (step S300). Further, the communication unit 202 sends, to the tactile presentation device 4, the response function r(f, k) generated by the generation unit, as the tactile presentation information (step S108), and the processing shown in FIG. 7 ends.

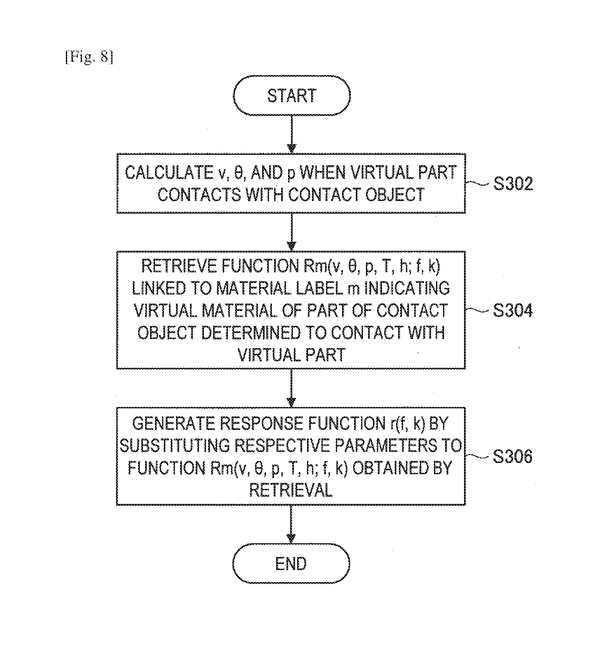

FIG. 8 is a flowchart showing an example of a flow of drive information generating processing (step S300) by the generation unit 210 in FIG. 7. In the processing in step S300, the generation unit 210 calculates the relative velocity v of the reference corresponding to the virtual part relative to the contact object, the relative moving direction 6 of the reference corresponding to the virtual part relative to the contact object, and the virtual pressure p applied to the contact object by the virtual part when the virtual part contacts with the contact object (step S302). Next, the generation unit 210 retrieves a function Rm(v, θ, p, T, h; f, k) linked to a material label m indicating a virtual material of a part of the contact object determined to contact with the virtual part, from the function library D10 stored in the function storing unit 204 (step S304). The generation unit 210 generates, as the oscillation information, the response function r(f, k) showing a relationship among the time frequency f, the spatial frequency k, and the amplitude by substituting the respective parameters to the function R (step S306), and the processing shown in FIG. 8 ends.

(Processing Performed by Tactile Presentation Device)

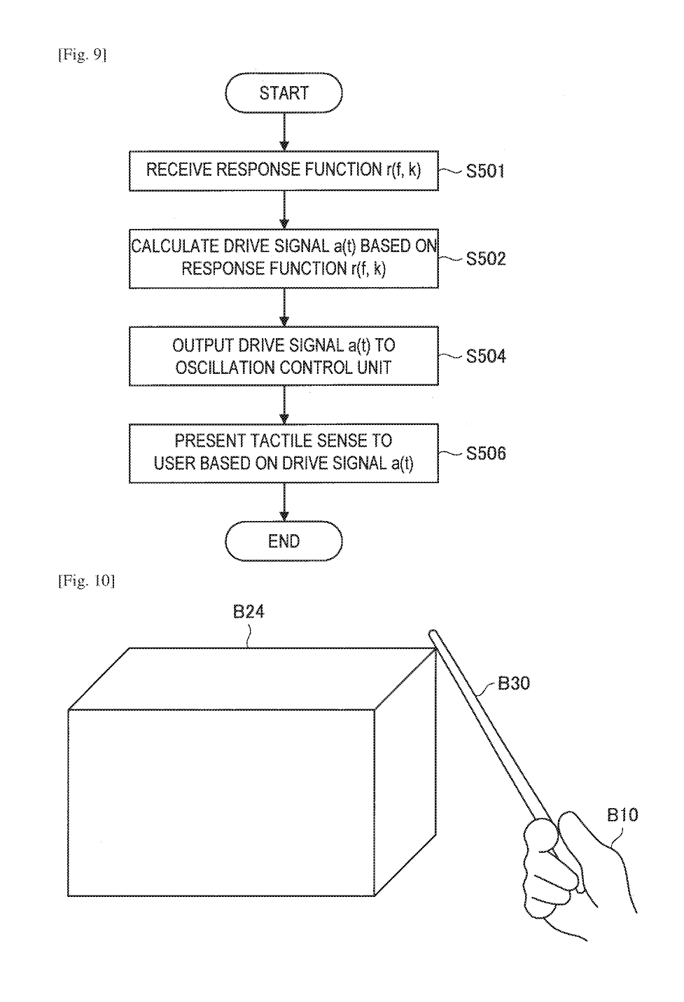

FIG. 9 is a flowchart showing an example of a flow of processing performed by the tactile presentation device 4 according to an embodiment. As shown in FIG. 9, the communication unit 408 first receives the response function r(f, k) generated by the information processing apparatus 2 as the oscillation information from the information processing apparatus 2 (step S501), and outputs the received information to the drive-signal calculating unit 406. Next, the drive-signal calculating unit 406 calculates the drive signal a(t) for generating the oscillations corresponding to the response function r(f, k) output from the communication unit 408 with the oscillating unit 402 (step S502). Subsequently, the drive-signal calculating unit 406 outputs the drive signal a(t) to the oscillation control unit 404 (step S504). Next, the oscillating unit 402 generates the oscillations based on the operation instruction from the oscillation control unit 404, thereby presenting the tactile sense to the user based on the drive signal a(t) (step S506), and the processing shown in FIG. 9 ends.

### 4. Application Example

In the above, the description is given of the example of presenting the tactile sense to the user when the virtual part as an object in the virtual space corresponding to the part of the user in the real space contacts with the contact object. However, the tactile sense may be presented to the user also in another case. For example, it is assumed that the virtual contact object as an object that contacts with at least a part of the virtual part in the virtual space is moved in response to the movement of the part of the user in the real space. Cases in which at least a part of the virtual part contacts with the virtual contact object include, for example, a case where the virtual contact object is grasped by the virtual part or a case where the virtual contact object is attached to the virtual part. In such cases, when the relevant virtual contact object contacts with the contact object, the tactile sense may be presented to the user. Hereinbelow, a description will be given of an application example of presenting the tactile sense to the user when the virtual part indirectly contacts with the contact object via an object different from the virtual part.

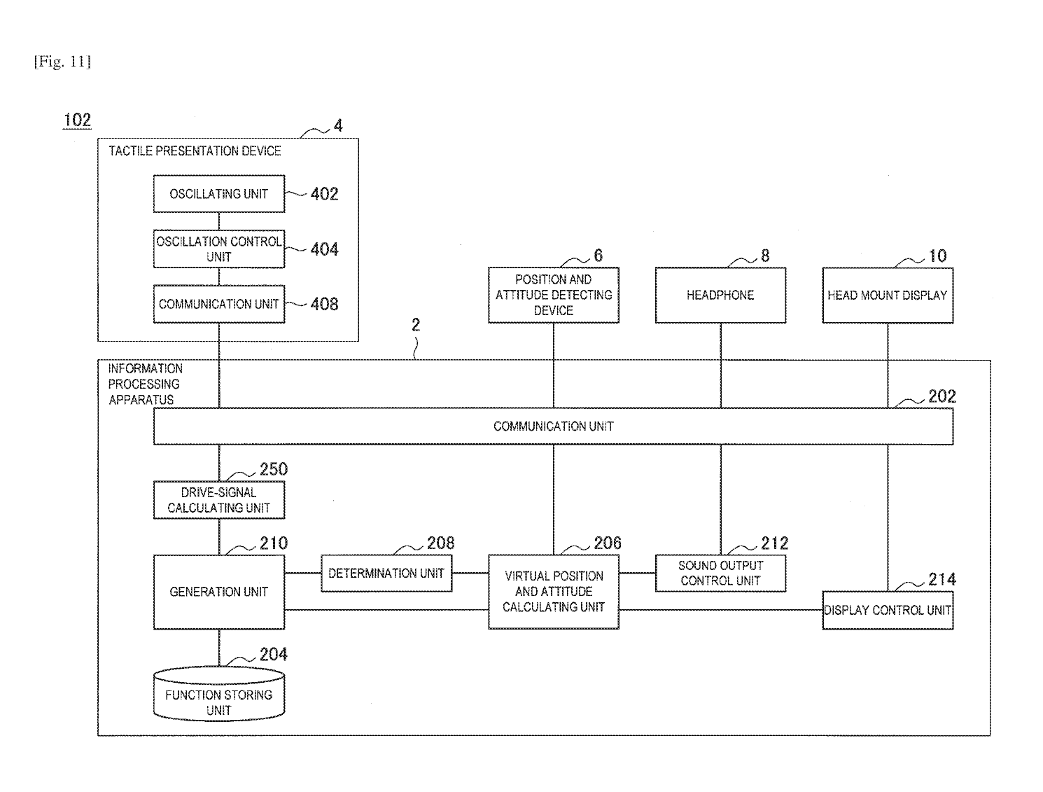

Here, a description will be given of an example of grasping a virtual stick as an object different from a virtual hand as an object in the virtual space corresponding to the hand of the user in the real space by the virtual hand. As shown in FIG. 10, in the virtual space, a virtual stick B30 is grasped by a virtual hand B10, thereby contacting with at least a part of the virtual hand B10. Here, the virtual stick B30 corresponds to an example of a second virtual object according to an embodiment of the present disclosure displayed based on the reference moved in the virtual space in response to the movement of the part of the user in the real space. A contact object B24 corresponds to an example of the first virtual object according to an embodiment of the present disclosure that contacts with the second virtual object in the virtual space.

In the application example, the generation unit 210 generates the oscillation information based on a virtual material of an inclusion including at least the second virtual object, intervening between the virtual part and the first virtual object when the second virtual object that is moved in the virtual space in response to the movement of the part of the user in the real space contacts with the first virtual object. In an example shown in FIG. 10, since the virtual stick B30 intervenes between the virtual hand B10 and the contact object B24, the generation unit 210 generates the oscillation information based on the virtual material of the virtual stick B30 as an inclusion.

The generation unit 210 may, for example, correct the response function r(f, k) depending on the virtual hardness of the inclusion in the generation of the response function r(f, k). Specifically, the generation unit 210 may correct the response function r(f, k) so as to reduce more amplitudes in a high-frequency area of the time frequency f as the virtual hardness of the inclusion is softer. Thus, when the inclusion is an object made of a soft material such as a wood, it is possible to make the user perceive the oscillations in which a high-frequency component of the time frequency is attenuated as compared with a case where the inclusion is an object made of a hard material such as metal. Therefore, it is possible to more precisely present the tactile sense.

Note that the function library stored in the function storing unit 204 may include a function linked to the information indicating the virtual material of the inclusion. The generation unit 210 may retrieve the function linked to the information indicating the virtual material of the inclusion and generate the response function r(f, k) by using the relevant function. In such a function library, the material label m of the contact object shown by referring to FIG. 6, the material label n indicating the virtual material of the inclusion, and a function Rmn(v, θ, p, T, h; f, k) are linked to each other. Specifically, a material label ‘thick sheet (coarse)’ of the contact object, a material label ‘wood’ of the inclusion, and a function R of a thick sheet (coarse), and a wood (v, θ, p, T, h; f, k) are linked to each other.

Note that the second virtual object that contacts with the contact object may contact with at least a part of the virtual part and an inclusion further may intervene between the second virtual object and the virtual part. For example, a virtual glove is attached to the virtual hand and the virtual stick is grasped via the relevant virtual glove. In this state, when the virtual stick contacts with the contact object, the virtual glove intervenes between the virtual stick corresponding to the second virtual object and the virtual hand as the virtual part. Therefore, the virtual stick and the virtual glove intervene between the virtual part and the contact object. In this case, the generation unit 210 may generate the oscillation information based on the virtual materials of the virtual stick and the virtual glove. As mentioned above, the generation unit 210 may generate the oscillation information based on the virtual materials of a plurality of inclusions intervening between the virtual part and the contact object.

### 5. Modification

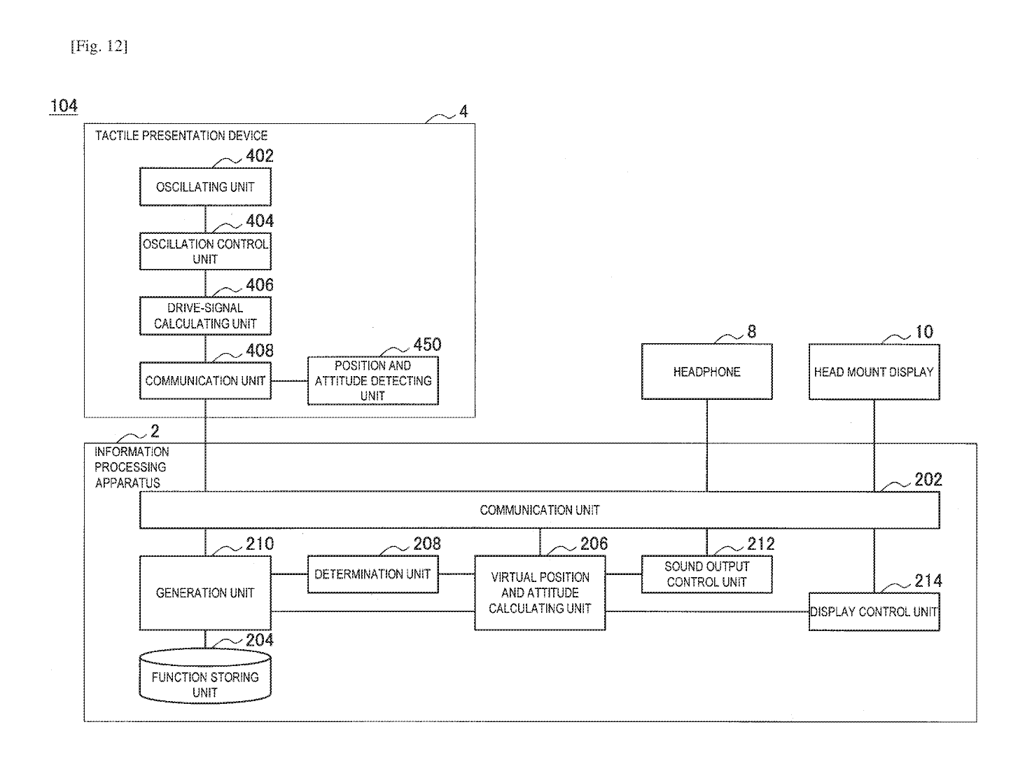

Subsequently, a description will be given of a virtual-space presentation system according to various modifications with reference to FIGS. 11 to 14.

### First Modification

FIG. 11 is an explanatory diagram showing an example of a system configuration of a virtual-space presentation system 102 according to a first modification. As compared with the virtual-space presentation system 1 according to an embodiment shown in FIG. 3, the virtual-space presentation system 102 according to the first modification is different in a point that the information processing apparatus 2 calculates the drive signal a(t) for driving the oscillating unit 402 of the tactile presentation device 4.

As shown in FIG. 11, the information processing apparatus 2 according to the first modification has a drive-signal calculating unit 250. According to the first modification, the generation unit 210 outputs the generated oscillation information to the drive-signal calculating unit 250. Further, the drive-signal calculating unit 250 calculates the drive signal a(t) for driving the oscillating unit 402 in the tactile presentation device 4 based on the oscillation information output from the generation unit 210 so as to make the user perceive the oscillations shown by the oscillation information, and outputs the signal to the communication unit 202. The communication unit 202 sends, to the tactile presentation device 4, the drive signal a(t) as the tactile presentation information for making the user perceive the oscillation by the tactile presentation device 4. Note that, as shown in FIG. 11, the drive-signal calculating unit can be omitted from the configuration of the tactile presentation device 4 according to the first modification.

### Second Modification

FIG. 12 is an explanatory diagram showing an example of a system configuration of a virtual-space presentation system 104 according to a second modification. As compared with the virtual-space presentation system 1 according to an embodiment shown in FIG. 3, the virtual-space presentation system 104 according to the second modification is different in a point of detecting the position and attitude of the tactile presentation device 4 in the real space by the tactile presentation device 4 and sending a detection result to the information processing apparatus 2.

As shown in FIG. 12, the tactile presentation device 4 according to the second modification includes a position and attitude detecting unit 450. The position and attitude detecting unit 450 detects the position and attitude of the tactile presentation device 4 in the real space, and outputs the detection result to a communication unit 408. The communication unit 408 according to the second modification sends the relevant detection result to the information processing apparatus 2. Note that the detection of the position and attitude of the tactile presentation device 4 with the position and attitude detecting unit 450 is performed similarly to the detection of the position and attitude of the tactile presentation device 4 with the position and attitude detection device 6 according to an embodiment mentioned above. Further, as shown in FIG. 12, the position and attitude detection device can be omitted from the configuration of the virtual-space presentation system 104 according to the second modification.

### Third Modification

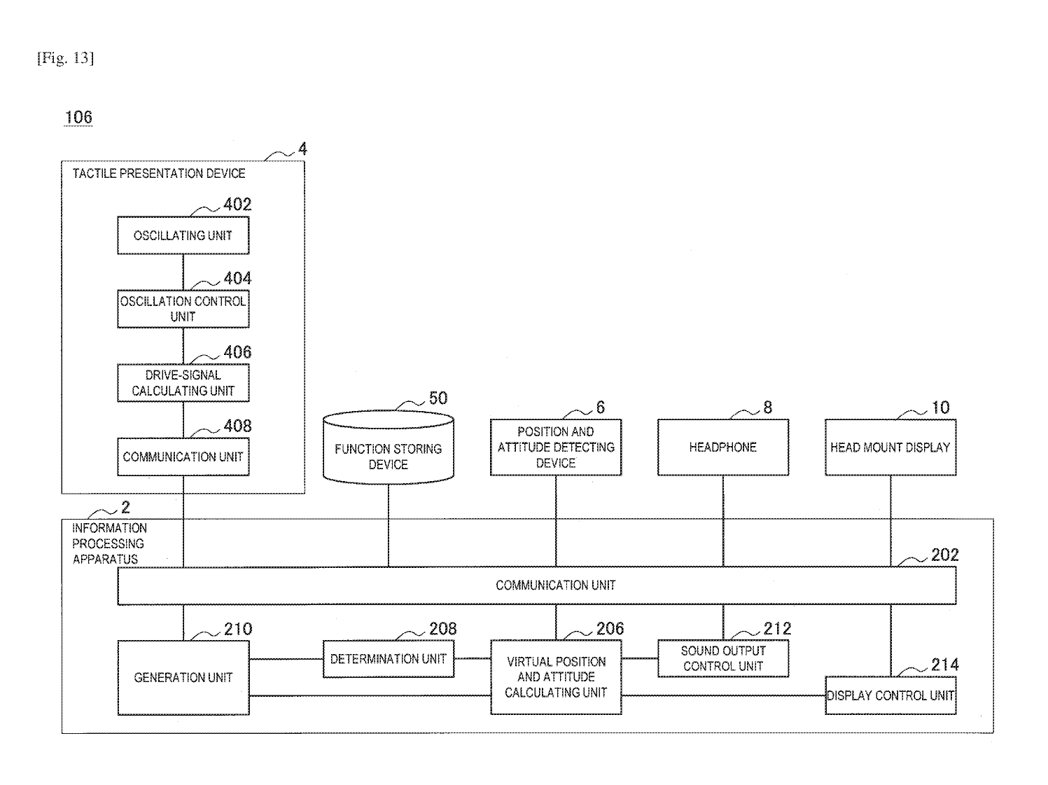

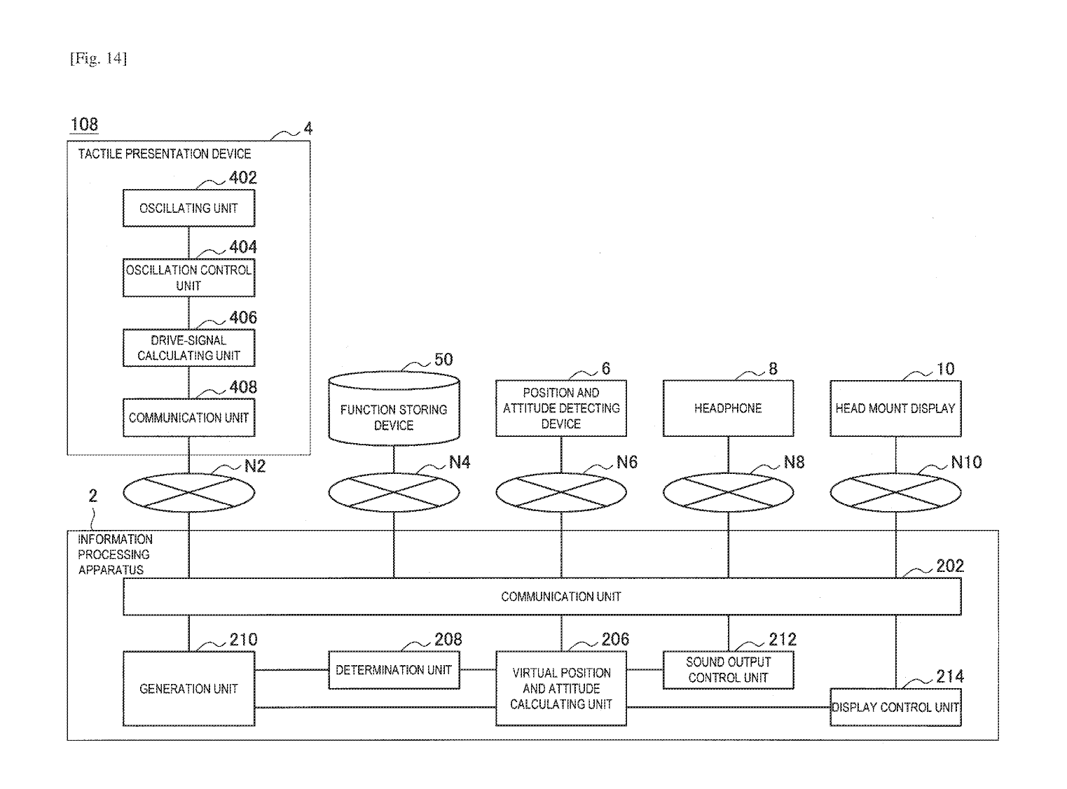

FIG. 13 is an explanatory diagram showing an example of a system configuration of a virtual-space presentation system 106 according to a third modification. As compared with virtual-space presentation system 1 according to an embodiment shown in FIG. 3, the virtual-space presentation system 106 according to the third modification is different in a point of storing the function library to a function storing device 50 as an external device of the information processing apparatus 2.

As shown in FIG. 13, the virtual-space presentation system 106 according to the third modification includes the function storing device 50. The function storing device 50 stores a function library as a set of candidates of a function for generating the oscillation information. The function library stored in the function storing device 50 is similar to the function library stored in the function storing unit 204 according to an embodiment. According to the third modification, the communication unit 202 in the information processing apparatus 2 communicates with the function storing device 50. Further, the generation unit 210 retrieves a function R from the function library stored in the function storing device 50 via the communication unit 202 in the generation of the oscillation information. Note that, as shown in FIG. 13, the function storing unit can be omitted from the configuration of the information processing apparatus 2 according to the third modification.

### Fourth Modification

FIG. 14 is an explanatory diagram showing an example of a system configuration of a virtual-space presentation system 108 according to a fourth modification. As compared with the virtual-space presentation system 106 according to the third modification shown in FIG. 13, the virtual-space presentation system 108 according to the fourth modification is different in a point that the information processing apparatus 2 communicates with an external device via an information network.

As shown in FIG. 14, in the virtual-space presentation system 108 according to the fourth modification, the information processing apparatus 2 communicates with the tactile presentation device 4, the function storing device 50, the position and attitude detection device 6, the headphone 8, and the head mount display 10 respectively via information networks N2, N4, N6, N8, and N10. Note that the information processing apparatus 2 may communicate with a part of external devices not-via an information network.

### 6. Hardware Configuration

As mentioned above, an embodiment of the present disclosure is described. The processing of the information processing apparatus 2 mentioned above is realized in cooperation with software and hardware of the information processing apparatus 2, which will be described below.

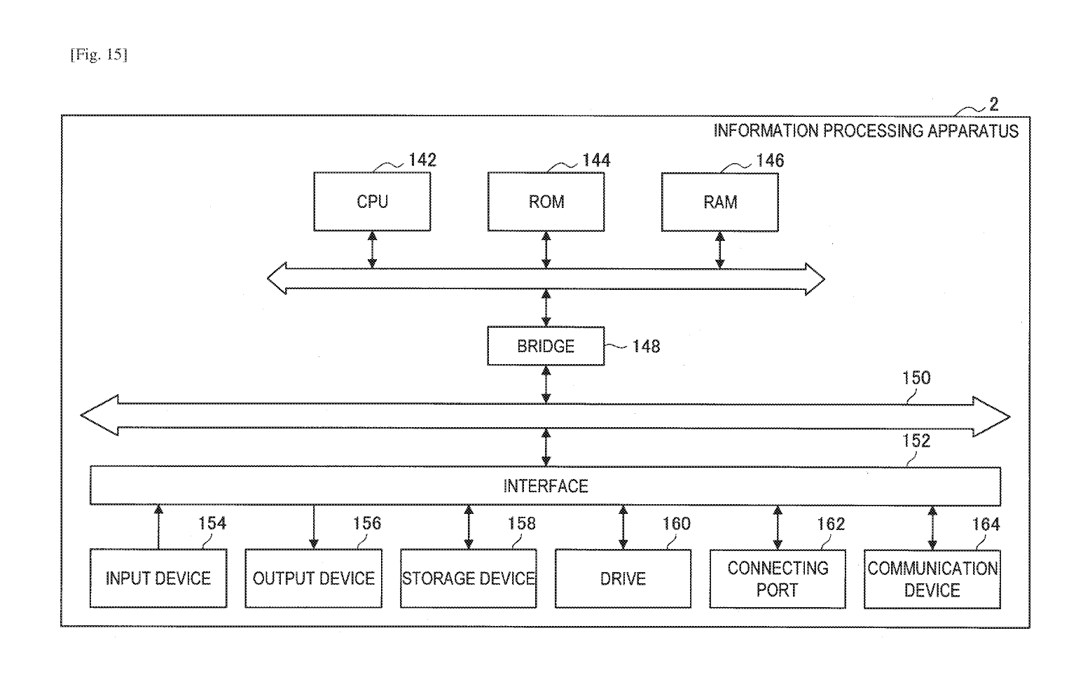

FIG. 15 is an explanatory diagram showing an example of a hardware configuration of the information processing apparatus 2 according to an embodiment of the present disclosure. As shown in FIG. 15, the information processing apparatus 2 includes a central processing unit (CPU) 142, a read only memory (ROM) 144, a random access memory (RAM) 146, a bridge 148, a bus 150, an interface 152, an input device 154, an output device 156, a storage device 158, a drive 160, a connecting port 162, and a communication device 164.

The CPU 142 functions as an operation processing device and a control device, and realizes operations of respective functional components of the information processing apparatus 2 in cooperation with various programs. Further, the CPU 142 may be a microprocessor. The ROM 144 stores a program, an operation parameter, or the like, used by the CPU 142. The RAM 146 temporarily stores a program used in execution of the CPU 142, a parameter that properly changes in the execution, or the like. The CPU 142, the ROM 144, and the RAM 146 are mutually connected via an internal bus having a CPU bus or the like.

The input device 154 is an input unit, such as a mouse, a keyboard, a touch panel, a button, a microphone, a switch, and a lever, for an operator to input information, and includes an input control circuit or the like that generates an input signal based on an input by the operator and outputs the signal to the CPU 142. An operator of the information processing apparatus 2 operates the input device 154, thereby inputting various data or instructing a processing operation to the information processing apparatus 2.

The output device 156 performs, for example, an output to devices such as a liquid crystal display (LCD) device, an organic light emitting diode (OLED) device, or a lamp. Further, the output device 156 may perform an audio output of a speaker, a headphone, or the like.

The storage device 158 is a device for storing data. Further, the storage device 158 may include a storage medium, a recording device that records data on the storage medium, a reading device that reads data from the storage medium, a deleting device that deletes data recorded in the storage medium, and the like. The storage device 158 stores a program executed by the CPU 142 or various data.

The drive 160 is a reader/writer for a storage medium, and is incorporated in the information processing apparatus 2 or externally attached thereto. The drive 160 reads information recorded in an attached magnetic disk, optical disk, magneto-optical disk, or a removable storage medium such as a semiconductor memory, and outputs the information to the RAM 146. Furthermore, the drive 160 can also write the information on the removable storage medium.

The connecting port 162 is a bus that connects to an external information processing apparatus or a peripheral device of the information processing apparatus 2. Further, the connecting port 162 may be a universal serial bus (USB).

For example, the communication device 164 is a communication interface configured with a communication device for connection to a network. Further, the communication device 164 may be a device supporting infrared communication, a communication device supporting a wireless local area network (LAN), a communication device supporting long term evolution (LTE), or a wire communication device performing communication using a wire.

Note that it is possible to produce a computer program for realizing respective functions of the information processing apparatus 2 according to an embodiment as mentioned above and implement the program in a PC or the like. The information processing apparatus 2 according to an embodiment can correspond to the computer according to an embodiment of the present disclosure. Further, it is possible to provide a computer-readable recording medium that stores such a computer program. The recording medium is, e.g., a magnetic disk, an optical disk, a magneto-optical disk, or a flash memory. Further, the computer program may be distributed, for example, via a network without using a recording medium. Moreover, the respective functions of the information processing apparatus 2 according to an embodiment may be divided by a plurality of computers. In this case, the respective functions provided for the relevant plurality of computers can be realized by the computer program. The relevant plurality of computers or one computer having the respective functions of the information processing apparatus 2 according to an embodiment corresponds to a computer system according to an embodiment of the present disclosure.

### 7. Conclusion

As mentioned above, the information processing apparatus 2 according to an embodiment of the present disclosure generates the tactile information indicating the tactile sense to be perceived by the user based on the relative moving direction of the reference moved in the virtual space in response to the movement of the operation body in the real space relative to the first virtual object in the virtual space. As a consequence, it is possible to make the user perceive proper tactile sense in accordance with the relative moving direction of the relevant reference relative to the first virtual object. Therefore, it is possible to more precisely present the tactile sense.

The above description is given of the example of applying the information processing apparatus 2 to the system using the virtual reality. However, a technical scope of the present disclosure is not limited to the example. For instance, the information processing apparatus 2 according to an embodiment of the present disclosure can be applied also to augmented reality.

The above description is given of the example of using the head mount display 10 as a display device that displays an image showing respective objects in the virtual space. However, a technical scope of the present disclosure is not limited to the example. For instance, a display device that is available in a state not mounted on the head may be used. Further, the above description is given of the example of using the headphone 8 as a sound output device that outputs sound for expressing sound in the virtual world. However, a technical scope of the present disclosure is not limited to the example. For instance, a sound output device that is available in a state not mounted on the head may be used.

The above description is given of the example of specifying, by the generation unit 210, the virtual material of the contact object having possibility of contacting with the virtual part depending on scenes in the virtual space. However, a technical scope of the present disclosure is not limited to the example. For instance, the generation unit 210 may specify the virtual material of the contact object with possibility of contacting with the virtual part depending on the current time. Further, the generation unit 210 may specify the virtual material of the contact object with possibility of contacting with the virtual part depending on the current position of the user. Such a case is considered of setting a type of objects existing in the virtual space depending on the time or user's position. In such a case, it is possible to properly specify the virtual material of the contact object with possibility of contacting with the virtual part.

The above description is given of the example in which the position and attitude detection device 6 detects the position and attitude of the tactile presentation device 4 from the image obtained by the imaging processing. However, a technical scope of the present disclosure is not limited to the example. For instance, the position and attitude detection device 6 may have a mechanism for irradiating an object with electromagnetic waves or sonic waves and detecting reflection waves of the electromagnetic waves or sonic waves from the relevant object to detect the position and attitude of the tactile presentation device 4 based on the time until the reflection waves are detected after irradiation of the electromagnetic waves or sonic waves. The position and attitude detection device 6 may detect, for example, the position and attitude of the tactile presentation device 4 by scanning an inside of a movable area of the tactile presentation device 4 by repeating the irradiation and detection of the reflection waves while sequentially changing an irradiating direction of the electromagnetic waves or sonic waves. The above description is given of the example in which the tactile presentation device 4 generates the oscillations of the oscillator to make the user perceive the oscillations. However, a technical scope of the present disclosure is not limited to the example. For instance, the tactile presentation device 4 may apply electric stimulation to the user based on the operation instruction from the oscillation control unit 404 to make the user perceive the oscillations.

The above description is given of the example of applying the part of the user as the operation body. However, a technical scope of the present disclosure is not limited to the example. For instance, a member for operation used by the user such as a stylus may be applied as the operation body.

The above description is given of the example in which the information processing apparatus 2 generates the oscillation information indicating the oscillations as the tactile sense to be perceived by the user as the tactile information. However, a technical scope of the present disclosure is not limited to the example. For instance, electric stimulation, thermal stimulation, ultrasonic stimulation or the like may be applied as the tactile sense in addition to oscillations. The information processing apparatus 2 can generate the tactile information indicating the tactile sense to be perceived by the user.

Further, as the function R included in the function library, information expressing a relationship among a finite number of representative values about the respective parameters, a finite number of representative values of the time frequency f, a finite number of representative values of the spatial frequency k, and the amplitude in a data table format may be used. The generation unit 210 may obtain a relationship between a parameter that is not prescribed in the information expressed in the data table format and an amplitude of the time frequency f or the spatial frequency k with interpolation to generate the oscillation information.

Note that a series of control processing with devices described in this specification may be realized by using any of software, hardware, and combination of software and hardware.

Programs forming software are stored in advance, for example, on a storage medium (non-transitory media) that is provided inside or outside the respective devices. Further, the respective programs are read to the RAM at execution time, for example, and are executed by a processor such as a CPU.

Note that it is not necessary for the processing described in this specification with reference to the flowchart to be executed in the order shown in the flowchart. Some processing steps may be performed in parallel. Further, some of additional steps can be adopted, or some processing steps can be omitted.

It should be understood by those skilled in the art that various modifications, combinations, sub-combinations and alterations may occur depending on design requirements and other factors insofar as they are within the scope of the appended claims or the equivalents thereof.

Further, the effects described in this specification are merely illustrative or exemplified effects, and are not limitative. That is, with or in the place of the above effects, the technology according to the present disclosure may achieve other effects that are clear to those skilled in the art based on the description of this specification.

Additionally, the present technology may also be configured as below.

(1)

An information processing apparatus including: a generation unit configured to generate tactile information indicating a tactile sense to be perceived by a user based on a relative moving direction of a reference position relative to a first virtual object in a virtual space, the reference position being moved in the virtual space in response to movement of an operation body in a real space; and

an output unit configured to output tactile presentation information for making the user perceive the tactile sense with a tactile presentation device configured to perform tactile presentation based on the tactile presentation information,

the generation unit and the output unit each being implemented via at least one processor.

(2)

The information processing apparatus according to (1), further including: a display control unit configured to display a second virtual object based on the reference position,

the display control unit being implemented via at least one processor.

(3)

The information processing apparatus according to (1) or (2), wherein the generation unit is further configured to generate the tactile information based on the relative moving direction of the reference position relative to the first virtual object in a state in which it is determined that the first virtual object and the second virtual object are in contact with each other.

(4)

The information processing apparatus according to any of (1) to (3), wherein the generation unit is further configured to generate the tactile information differently between a first case where the relative moving direction of the reference position relative to the first virtual object is a first direction and a second case where the relative moving direction is a second direction different from the first direction.

(5)

The information processing apparatus according to any of (1) to (4), wherein the generation unit is further configured to generate the tactile information based on information indicating characteristics of a first contacted part of the first virtual object, the first contacted part being determined to be in contact with the second virtual object.

(6)

The information processing apparatus according to any of (1) to (5), wherein the information indicating the characteristics includes information indicating a virtual material of the first contacted part.

(7)

The information processing apparatus according to any one of (1) to (6), wherein the generation unit is further configured to generate the tactile information based on a relative velocity of the reference position relative to the first virtual object.

(8)

The information processing apparatus according to any of (1) to (7), wherein the generation unit is further configured to generate the tactile information based on information indicating a virtual pressure applied to the first virtual object by the second virtual object.

(9)

The information processing apparatus according to any of (1) to (8), wherein the information indicating the characteristics includes information indicating a virtual temperature of the first contacted part.

(10)

The information processing apparatus according to any of (1) to (9), wherein the information indicating the characteristics includes information indicating a virtual humidity of the first contacted part.

(11)

The information processing apparatus according to any one of (1) to (10), wherein the operation body is a part of a body of the user, and the generation unit is further configured to generate the tactile information based on information indicating a degree of sweating of the part of the body.

(12)

The information processing apparatus according to any one of (1) to (11), wherein the tactile information includes information indicating a relationship among a time frequency, a spatial frequency and amplitude of the tactile sense to be perceived by the user.

(13)

The information processing apparatus according to any of (1) to (12), wherein the generation unit is further configured to: retrieve, from a plurality of candidates of functions for generating the tactile information, at least one function linked to the information indicating the virtual material, each candidate of the plurality of candidates being linked to information indicating a corresponding material and stored in advance; and generate the tactile information based on the retrieved at least one function.

(14)

The information processing apparatus according to any of (1) to (13), wherein the plurality of candidates include at least one candidate linked to information indicating the virtual material of the first virtual object that is in contact with the second virtual object, and the generation unit is further configured to retrieve the at least one function according to the at least one candidate.

(15)

The information processing apparatus according to any one of (1) to (14), wherein the tactile presentation device is further configured to perform the tactile presentation by transmitting an oscillation of an oscillator controlled based on the tactile presentation information to a skin of the user.

(16)

The information processing apparatus according to any of (1) to (15), wherein the tactile presentation information includes information for controlling a time frequency or an amplitude of the oscillation generated by the oscillator.

(17)

The information processing apparatus according to any of (1) to (16), wherein the generation unit is further configured to generate the tactile information based on information indicating characteristics of a second contacted part of the second virtual object, the second contacted part being determined to be in contact with the first virtual object.

(18)

The information processing apparatus according to any of (1) to (17), wherein the generation unit is further configured to generate the tactile information based on information indicating a virtual material of the second contacted part.

(19)

The information processing apparatus according to any of (1) to (18), wherein the second direction is substantially opposite to the first direction.

(20)

An information processing method, implemented via at least one processor, the method including:

generating tactile information indicating a tactile sense to be perceived by a user based on a relative moving direction of a reference position relative to a first virtual object in a virtual space, the reference position being moved in the virtual space in response to movement of an operation body in a real space; and

outputting tactile presentation information for making the user perceive the tactile sense with a tactile presentation device configured to perform tactile presentation based on the tactile presentation information.

(21)

A non-transitory computer-readable medium having embodied thereon a program, which when executed by a computer, causes the computer to execute a method, the method including: generating tactile information indicating a tactile sense to be perceived by a user based on a relative moving direction of a reference position relative to a first virtual object in a virtual space, the reference position being moved in the virtual space in response to movement of an operation body in a real space; and

outputting tactile presentation information for making the user perceive the tactile sense with a tactile presentation device that performs tactile presentation based on the tactile presentation information.

(22)

An information processing apparatus including:

a generation unit configured to generate tactile information indicating tactile sense to be perceived by a user based on a relative moving direction of a reference moved in a virtual space in response to movement of an operation body in a real space relative to a first virtual object in the virtual space; and

an output unit configured to output tactile presentation information for making the user perceive the tactile sense by a tactile presentation device that performs tactile presentation.

(23)

The information processing apparatus according to (22), further including: a display control unit configured to have a second virtual object displayed based on the reference.

(24)

The information processing apparatus according to (23), wherein the generation unit generates the tactile information based on the relative moving direction of the reference relative to the first virtual object in a state in which it is determined that the first virtual object and the second virtual object are in contact with each other.

(25)

The information processing apparatus according to (24), wherein the generation unit generates the tactile information different between a case where the relative moving direction of the reference relative to the first virtual object is a first direction and a case where the relative moving direction is a second direction substantially opposite to the first direction.

(26)

The information processing apparatus according to (24) or (25), wherein the generation unit generates the tactile information based on information indicating characteristics of a part of the first virtual object determined to be in contact with the second virtual object.

(27)

The information processing apparatus according to (26), wherein the generation unit generates the tactile information based on information indicating a virtual material of a part of the first virtual object determined to be in contact with the second virtual object.

(28)

The information processing apparatus according to any one of (22) to (27), wherein the generation unit generates the tactile information based on a relative velocity of the reference relative to the first virtual object.

(29)

The information processing apparatus according to (26) or (27), wherein the generation unit generates the tactile information based on information indicating a virtual pressure applied to the first virtual object by the second virtual object.

(30)

The information processing apparatus according to (26) or (27), wherein the generation unit generates the tactile information based on information indicating a virtual temperature of a part of the first virtual object determined to be in contact with the second virtual object.

(31)

The information processing apparatus according to (26) or (27), wherein the generation unit generates the tactile information based on information indicating a virtual humidity of a part of the first virtual object determined to be in contact with the second virtual object.

(32)

The information processing apparatus according to any one of (24) to (27), wherein the operation body is a part of a body of the user, and the generation unit generates the tactile information based on information indicating a degree of sweating of the part of the body.

(33)

The information processing apparatus according to any one of (22) to (32), wherein the tactile information includes information indicating a relationship among a time frequency, a spatial frequency and an amplitude.

(34)

The information processing apparatus according to (26) or (27), wherein the generation unit retrieves, from candidates of a function for generating the tactile information that is linked to information indicating each material and stored in advance, the function linked to information indicating a virtual material of a part of the first virtual object determined to be in contact with the second virtual object, and generates the tactile information by using the retrieved function.

(35)

The information processing apparatus according to (34), wherein the generation unit retrieves the function from the candidates of a function linked to information indicating a virtual material of the first virtual object with possibility to be in contact with the second virtual object among the candidates of the function.

(36)

The information processing apparatus according to any one of (22) to (35), wherein the tactile presentation device performs the tactile presentation by transmitting an oscillation of an oscillator controlled based on the tactile presentation information to a skin of the user.

(37)

The information processing apparatus according to (36), wherein the tactile presentation information includes information for controlling a time frequency or an amplitude of the oscillation generated by the oscillator.

(38)

The information processing apparatus according to (26) or (27), wherein the generation unit generates the tactile information based on information indicating characteristics of a part of the second virtual object determined to be in contact with the first virtual object.

(39)

The information processing apparatus according to (38), wherein the generation unit generates the tactile information based on information indicating a virtual material of a part of the second virtual object determined to be in contact with the first virtual object.

(40)

An information processing method including: generating, by an information processing apparatus, tactile information indicating tactile sense to be perceived by a user based on a relative moving direction of a reference moved in a virtual space in response to movement of an operation body in a real space relative to a first virtual object in the virtual space; and

outputting tactile presentation information for making the user perceive the tactile sense by a tactile presentation device that performs tactile presentation.

(41)

A program for causing a computer system to function as:

a generation unit configured to generate tactile information indicating tactile sense to be perceived by a user based on a relative moving direction of a reference moved in a virtual space in response to movement of an operation body in a real space relative to a first virtual object in the virtual space; and

an output unit configured to output tactile presentation information for making the user perceive the tactile sense by a tactile presentation device that performs tactile presentation.

### REFERENCE SIGNS LIST

1, 102, 104, 106, 108 virtual-space presentation system

2 information processing apparatus

4, 4a tactile presentation device

6 position and attitude detection device

8 headphone

10 head mount display

50 function storing device

142 CPU

144 ROM

146 RAM

148 bridge

150 bus

152 interface

154 input device

156 output device

158 storage device

160 drive

162 connecting port

164 communication device

202 communication unit

204 function storing unit

206 virtual position and attitude calculating unit

208 determination unit

210 generation unit

212 sound output control unit

214 display control unit

250 drive-signal calculating unit

402 oscillating unit

404 oscillation control unit

406 drive-signal calculating unit

408 communication unit

450 position and attitude detecting unit

1. An information processing apparatus comprising:
a generation unit configured to generate tactile information indicating a tactile sense to be perceived by a user based on a relative moving direction of a reference position relative to a first virtual object in a virtual space, the reference position being moved in the virtual space in response to movement of an operation body in a real space; and
an output unit configured to output tactile presentation information for making the user perceive the tactile sense with a tactile presentation device configured to perform tactile presentation based on the tactile presentation information,
wherein the generation unit and the output unit are each implemented via at least one processor.

2. The information processing apparatus according to claim 1, further comprising:
a display control unit configured to display a second virtual object based on the reference position,
wherein the display control unit is implemented via at least one processor.

3. The information processing apparatus according to claim 2, wherein the generation unit is further configured to generate the tactile information based on the relative moving direction of the reference position relative to the first virtual object in a state in which it is determined that the first virtual object and the second virtual object are in contact with each other.

4. The information processing apparatus according to claim 3, wherein the generation unit is further configured to generate the tactile information differently between a first case where the relative moving direction of the reference position relative to the first virtual object is a first direction and a second case where the relative moving direction is a second direction different from the first direction.

5. The information processing apparatus according to claim 3, wherein the generation unit is further configured to generate the tactile information based on information indicating characteristics of a first contacted part of the first virtual object, the first contacted part being determined to be in contact with the second virtual object.

6. The information processing apparatus according to claim 5, wherein the information indicating the characteristics includes information indicating a virtual material of the first contacted part.

7. The information processing apparatus according to claim 1, wherein the generation unit is further configured to generate the tactile information based on a relative velocity of the reference position relative to the first virtual object.

8. The information processing apparatus according to claim 2, wherein the generation unit is further configured to generate the tactile information based on information indicating a virtual pressure applied to the first virtual object by the second virtual object.

9. The information processing apparatus according to claim 5, wherein the information indicating the characteristics includes information indicating a virtual temperature of the first contacted part.

10. The information processing apparatus according to claim 5, wherein the information indicating the characteristics includes information indicating a virtual humidity of the first contacted part.

11. The information processing apparatus according to claim 3, wherein the operation body is a part of a body of the user, and the generation unit is further configured to generate the tactile information based on information indicating a degree of sweating of the part of the body.

12. The information processing apparatus according to claim 4, wherein the second direction is substantially opposite to the first direction.

13. The information processing apparatus according to claim 6, wherein the generation unit is further configured to:
retrieve, from a plurality of candidates of functions for generating the tactile information, at least one function linked to the information indicating the virtual material, each candidate of the plurality of candidates being linked to information indicating a corresponding material and stored in advance; and
generate the tactile information based on the retrieved at least one function.

14. The information processing apparatus according to claim 13, wherein
the plurality of candidates include at least one candidate linked to information indicating the virtual material of the first virtual object that is in contact with the second virtual object, and
the generation unit is further configured to retrieve the at least one function according to the at least one candidate.

15. The information processing apparatus according to claim 1, wherein the tactile presentation device is further configured to perform the tactile presentation by transmitting an oscillation of an oscillator controlled based on the tactile presentation information to a skin of the user.

16. The information processing apparatus according to claim 15, wherein the tactile presentation information includes information for controlling a time frequency or amplitude of the oscillation generated by the oscillator.

17. The information processing apparatus according to claim 5, wherein the generation unit is further configured to generate the tactile information based on information indicating characteristics of a second contacted part of the second virtual object, the second contacted part being determined to be in contact with the first virtual object.

18. The information processing apparatus according to claim 17, wherein the generation unit is further configured to generate the tactile information based on information indicating a virtual material of the second contacted part.

19. An information processing method, implemented via at least one processor, the method comprising:
generating tactile information indicating a tactile sense to be perceived by a user based on a relative moving direction of a reference position relative to a first virtual object in a virtual space, the reference position being moved in the virtual space in response to movement of an operation body in a real space; and
outputting tactile presentation information for making the user perceive the tactile sense with a tactile presentation device configured to perform tactile presentation based on the tactile presentation information.

20. A non-transitory computer-readable medium having embodied thereon a program, which when executed by a computer, causes the computer to execute a method, the method comprising:
generating tactile information indicating a tactile sense to be perceived by a user based on a relative moving direction of a reference position relative to a first virtual object in a virtual space, the reference position being moved in the virtual space in response to movement of an operation body in a real space; and
outputting tactile presentation information for making the user perceive the tactile sense with a tactile presentation device configured to perform tactile presentation based on the tactile presentation information.
